(19) United States
(12) Patent Application Publication
(10) Pub. No.: US 2009/0244817 A1
(43) Pub. Date: Oct. 1, 2009

(54) Electrical Distribution System

(76) Inventor: Anthony R. Moyer, Harrington, DE (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/413,700

(22) Filed: Mar. 30, 2009

Related U.S. Application Data
(60) Provisional application No. 61/041,272, filed on Apr. 1, 2008.

(51) Int. Cl. H02B 1/04; H02B 1/015

(52) U.S. Cl. 361/634; 361/627

(57) ABSTRACT

An electrical distribution system includes a primary distribution panel connectable to a main power line; a plurality of primary circuit breakers located in the primary distribution panel; a plurality of primary electrical lines electrically connected to the primary circuit breakers; at least one secondary distribution panel electrically connected to the primary distribution panel by a secondary power line; one or more secondary circuit breakers in the secondary distribution panel; secondary electrical line(s) connected to the secondary circuit breakers; and a control device configured to control the flow of electrical power from the primary distribution panel to the secondary distribution panel.

### CROSS-REFERENCE TO RELATED APPLICATION

This application claims the benefit of U.S. Provisional Application No. 61/041,272, filed Apr. 1, 2008, herein incorporated by reference in its entirety.

### BACKGROUND OF THE INVENTION

1. Field of the Invention

This invention relates generally to electrical distribution systems and, in one particular embodiment, to an electrical distribution system having a primary distribution panel and one or more secondary distribution panels, with a control device to control power to the secondary distribution panel(s).

2. Description of the Current Technology

As the price of fuel escalates and energy usage continues to increase, more emphasis is being placed on reducing energy consumption. Energy conservation methods such as turning the lights off in unoccupied rooms, using lower wattage bulbs in lamps, and turning off electrical appliances when not in use are encouraged to help lower energy consumption and decrease the demand placed upon the local electrical power grid. While these actions are beneficial, improvements could be made to decrease energy consumption even further. For example, some non-essential electrical devices, such as but not limited to televisions, video recorders, toaster ovens, microwave ovens, computers, computer screens, and various other electronic articles, use power even when the article is turned off. Therefore, in order to completely eliminate the electrical power usage by such articles, the articles would have to be unplugged from the electrical outlet.

However, unplugging each of these items from an electrical outlet and then plugging them back in when they are desired to be used is a time and labor intensive operation. This is particularly true if a homeowner is leaving the home only for a short period of time. Most homeowners cannot be troubled to unplug all of their electronic items only to have to plug them back in a short time later. Moreover, for vacation homes or if the homeowner is going on vacation for an extended period, the homeowner may forget to unplug each electronic article before leaving. For office buildings, it would save time and effort if non-essential electronic or electrical devices could be quickly and easily disconnected from and reconnected to the power grid.

Therefore, it would be advantageous to provide an electrical distribution system in which selected electronic articles (non-essential or secondary users) could be quickly and easily disconnected from the electrical power grid when not in use, or when the homeowner will be absent for a period of time, while still maintaining electrical power to essential or primary users. It would be equally advantageous if this electrical distribution system could permit these secondary electronic articles to be quickly and easily reconnected to the electrical power grid when they are desired to be used or when the homeowner has returned.

### SUMMARY OF THE INVENTION

An electrical distribution system comprises: a primary distribution panel; at least one secondary distribution panel electrically connected to the primary distribution panel; and a control device in electrical connection with the primary distribution panel and the secondary distribution panel and configured to selectively control the flow of electricity from the primary distribution panel to the secondary distribution panel.

A further electrical distribution system comprises a primary distribution panel; at least one primary circuit breaker located in the primary distribution panel; at least one primary electrical line electrically connected to the primary circuit breakers; at least one secondary distribution panel electrically connected to the primary distribution panel; one or more secondary circuit breakers in the secondary distribution panel; one or more secondary electrical line(s) connected to the secondary circuit breakers; and a control device configured to selectively control the flow of electrical power from the primary distribution panel to the secondary distribution panel.

An additional electrical distribution system comprises: a primary distribution panel; a plurality of primary circuit breakers located in the primary distribution panel; a plurality of primary electrical lines electrically connected to the primary circuit breakers; at least one secondary distribution panel electrically connected to the primary distribution panel; at least one secondary circuit breaker in the secondary distribution panel; secondary electrical lines connected to the secondary circuit breakers; and a control device configured to control the flow of electrical power from the primary distribution panel to the secondary distribution panel, wherein the control device comprises a contactor connected to the primary distribution panel and the secondary distribution panel; a transformer connected to the contactor; and a controller connected to the transformer, the controller configured to selectively cause the transformer to open or close the contactor.

A still further electrical distribution system comprises: a primary distribution panel having a plurality of primary circuit breakers, connected to primary users; at least one secondary distribution panel connected to the primary distribution panel and having a plurality of secondary circuit breakers connected to secondary users; and a control device configured to control the flow of electrical power from the primary distribution panel to the secondary distribution panel, the control device comprising a three pole, single throw contactor; a transformer connected to the contactor; and a radio frequency receiver connected to the transformer, wherein the radio frequency receiver is configured to selectively cause the transformer to open or close the contactor.

A method of retrofitting an electrical distribution system comprises the steps of electrically connecting at least one control device to a primary distribution panel, the control device comprising: a contactor; a transformer connected to the contactor; and a radio frequency receiver connected to the transformer; electrically connecting at least one secondary distribution panel to the control device; designating one or more electrical consumers as secondary consumers; transferring an electrical connection for the secondary consumers from the primary distribution panel to the secondary distribution panel; and selectively controlling electricity to the secondary distribution panel by remotely sending a signal to the receiver to cause the transformer to open or close the contactor.

The advantages and features of the invention will become more apparent when considered with the following specification and accompanying drawing figures wherein like reference symbols identify like parts throughout.

### BRIEF DESCRIPTION OF THE DRAWINGS

FIG. 1 illustrates an electrical distribution system (not to scale) incorporating features of the invention;

FIG. 2 illustrates another embodiment of an electrical distribution system (not to scale) of the invention; and

FIG. 3 illustrates a control device (not to scale) of the invention.

### DESCRIPTION OF THE PREFERRED EMBODIMENTS

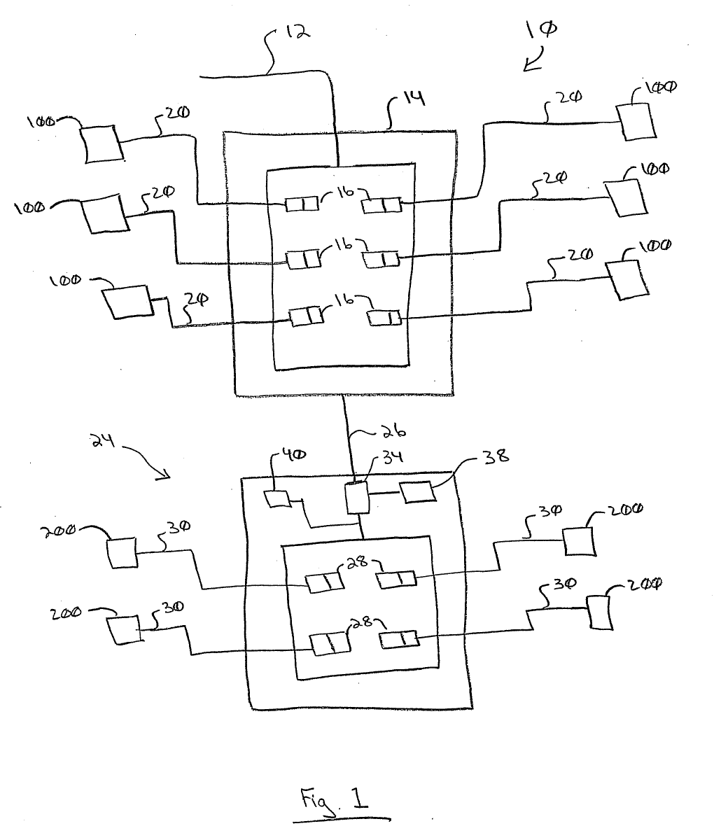

An electrical distribution system 10 is shown in FIG. 1. A main power cable or line 12 provides electricity from a conventional power grid to a primary distribution panel 14. The primary distribution panel 14 includes one or more primary circuit breakers 16, which may be of any conventional design. Several companies, including to but not limited to Westinghouse, General Electric, Cutler Hammer and Square D, manufacture distribution panels with circuit breakers that could be used in the present invention. As is known in the art, the circuit breakers 16 can be arranged in any conventional manner, such as in one or more, e.g., two columns. Primary electrical lines 20 extend between the circuit breakers 16 and various electrical consumers (primary users 100).

As will be appreciated by one skilled in the art, when a circuit breaker 16 is in the “on” position (i.e., closed), electricity flows from the main power line 12 through the circuit breaker 16, through the primary electrical line 20, and to the electrical consumer. However, when the circuit breaker 16 is in the “off” position (i.e., open), no electrical power flows through the associated primary electrical line 20. The construction and operation of a conventional panel box will be well understood by one of ordinary skill in the art and, therefore, will not be described in detail.

However, in the practice of the invention, at least one secondary distribution panel 24 is electrically connected to the primary distribution panel 14, such as, by a secondary power cable or line 26. The secondary distribution panel 24 includes one or more secondary circuit breakers 28 associated with secondary electrical lines 30. The secondary electrical lines 30 are connected with one or more electrical consumers (secondary users 200). In this embodiment, the secondary distribution panel 24 further includes a switch 34 in the circuit between the primary distribution panel 14 and the secondary distribution panel 24. In this embodiment, the switch 34 can be a conventional manual (on/off) switch or can be connected to a controller 38 to turn the switch 34 on or off (i.e., closed or open) remotely, as will be described in detail below. The switch 34 could be, for example, a conventional double pole/double throw switch. Additionally, an indicator 40 can be in electrical connection with the electrical circuit in the secondary distribution panel 24 to indicate whether electricity is flowing to the secondary distribution panel 24.

Operation of the electrical distribution system 10 will now be described.

In one aspect of the invention, the primary electrical lines 20 can be connected to (e.g., supply electrical energy to) primary users 100. By “primary user” is meant an electrical device designated to be of such importance that electrical power should be provided to this user at all times. Examples of such primary users could be, but are not limited to, security systems, heating systems, cooling systems, food storage and refrigeration systems, telephone systems, and the like. Thus, the main power line 12 supplies electrical energy to the primary distribution panel 14. When a selected primary circuit breaker 16 is in the “on” position (i.e., closed), electricity flows through the primary electrical line 20 to the primary user connected to that line. So far, the operation of the electrical distribution system 10 is very similar to that of known distribution systems.

However, in the practice of the invention, one or more secondary distribution panels 24 are electrically connected to the primary distribution panel 14. The secondary distribution panels 24 could be connected in series or in parallel to the primary distribution panel 14. FIG. 1 shows a single secondary distribution panel 24 connected to the primary distribution panel 14 by a secondary power line 26. In the practice of the invention, the secondary electrical lines 30 are connected to secondary users 200. By “secondary user” is meant a user that a homeowner or building supervisor has determined to be non-critical, such that electrical power can be disconnected from the secondary user when desired to reduce electrical power consumption.

In normal operating mode, the switch 34 is closed and electrical power flows from the main power line 12, through the primary distribution panel 14 (to the primary users), through the secondary power line 26, through the switch 34 and to the secondary circuit breakers 28. If the secondary circuit breakers 28 are closed, electrical power is supplied to the secondary users through the secondary electrical lines 30. Examples of such secondary users could be televisions, video recorders, computers, microwaves, toasters, kitchen electronics, lights, and the like. However, unlike conventional electrical distribution systems, when it is desirable to disconnect the secondary users from the electrical grid to save electricity, all an operator must do is open the switch 34. This prevents electricity flowing through the secondary distribution panel 24 to the secondary users. This would be useful, for example, if a homeowner were going on vacation, or even if the homeowner were simply leaving for work. In office buildings, when the occupants left for the evening, a security guard or similar individual could easily control the flow of electricity to one or more offices by opening the switch 34 (or switches 34 if multiple secondary distribution panels 24 were present). When the homeowner returned or before the start of the next business day, the switch 34 would be closed to allow electrical flow to the secondary distribution panel 24.

The switch 34 could be a conventional manual on/off switch which an operator could activate or inactivate manually. However, in another aspect of the invention, the switch 34 can be connected to a controller 38 such that the switch can be activated remotely. For example, the controller 38 could include a receiver that could be remotely operated in any conventional manner. For example, the transmitter could be similar to a conventional garage door transmitter and could be carried on a key ring. Alternatively, the controller 38 could be activated by a magnetic card (similar to a conventional hotel key card). Still further, the controller 38 could be connected to the home security system such that the switch 34 could be closed or opened from the home security system panel.

In another embodiment, an indicator 40, such as but not limited to a light or LED, can be connected to the electrical circuit of the secondary distribution panel 24 to indicate the status of the secondary distribution panel 24. That is, the indicator 40 could be illuminated to indicate that electricity is flowing to the secondary distribution panel 24 and not illuminated when the switch 34 is opened.

As will be appreciated by one of ordinary skill in the art, the electrical distribution system 10 of the invention provides a convenient way of controlling electrical flow to secondary users to decrease energy consumption.

In addition to conventional secondary users such as those described above, other secondary users could also be connected to the secondary distribution panel 24. For example, a solenoid valve can be provided in a utility line, such as a gas line or water line of the home. The solenoid can be connected to the secondary distribution panel 24 by a secondary electrical line 30. When the secondary distribution panel 24 is deenergized, the solenoid valve(s) would close, thus preventing water or gas flow into the home. This could help reduce the chances of flooding or gas leaks when the homeowners are away.

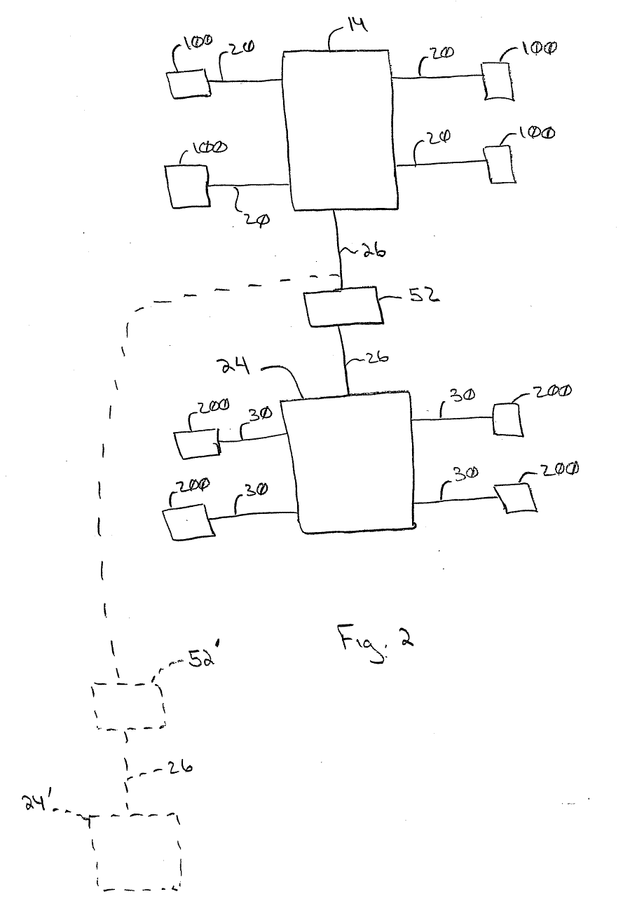

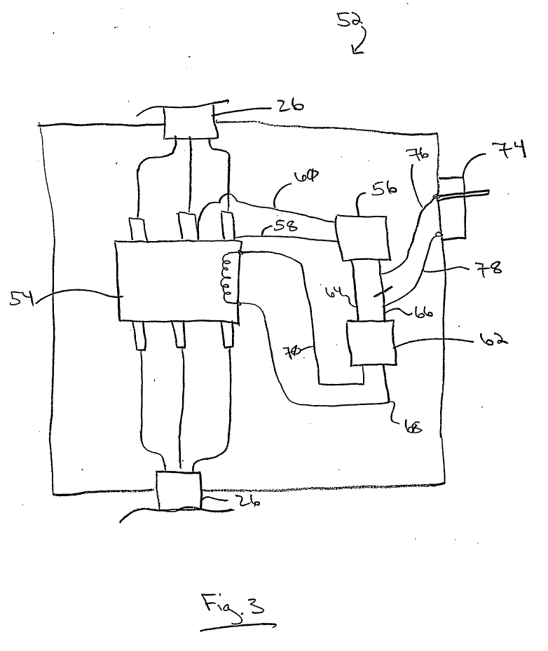

Another electrical distribution system 50 incorporating features of the invention is shown in FIGS. 2 and 3. The electrical distribution system 50 includes at least one primary distribution panel 14 and at least one secondary distribution panel 24, similar to those described above. In this embodiment, a control device 52 is positioned in the electrical circuit between the primary distribution panel 14 and the secondary distribution panel 24. In the illustrated embodiment, the control device 52 includes a conventional electrical contactor 54. In the broad practice of the invention, any conventional contactor could be used. In the illustrated embodiment, the contactor 54 is shown as a three pole contactor (single throw). In a specific non-limiting embodiment, the contactor is a 200 amp, three pole single throw, 24 VAC coil contactor.

In the illustrated embodiment, the control device 52 also includes a receiver 56, such as a conventional radio wave receiver. The receiver 56 is connected to the contactor 54 via electrical lines 58 (e.g., a 110 volt power line) and 60 (e.g., a neutral line).

A transformer 62 is in electrical connection with the receiver 56 via electrical lines 64 (e.g., a 110 volt power line) and 66 (e.g., a neutral line). In one non-limiting embodiment, the transformer 62 can be a conventional 24 VAC-75 VA with breaker 3.5 amp step-down transformer.

The transformer 62 is in contact with the contactor 54 via electrical lines 68 and 70. The control device 52 further includes a bypass switch 74 (such as, but not limited to, a conventional light toggle switch) in electrical connection with the electrical line 66 via electrical lines 76 and 78.

Operation of this distribution system 50 will now be described. In a normal operating mode, the contactor 54 is in the closed position such that electrical power flows from the primary distribution panel 14, through the control device 52, and into the secondary distribution panel 24 to the secondary consumers. When it is desirable to eliminate electrical power flowing to the secondary distribution panel 24, the contactor 54 is opened. In one embodiment, this can be done by depressing the bypass switch 74. This causes the transformer 62 to open the contactor 54, for example by de-energizing the transformer 62, which de-energizers the contactor 54 to cause the contactor 54 to open. When it is desirable to restore power to the secondary distribution panel 24, the bypass switch 74 could again be depressed to energize the transformer 62 and close the contactor 54.

In another aspect of the invention, the contactor 54 can be open and closed remotely. For example, when it is desirable to stop the flow of electrical power to the secondary distribution panel 24, an operator can send a radio signal to the receiver 56. Upon receipt of the signal, the receiver 56 can de-energize the transformer 62 to open the contactor 54 and thus eliminate power flow to the secondary distribution panel 24. When it is desirable to restore electrical power, another radio signal can be sent to the receiver 56 to energize the transformer 62 to close the contactor 54 and thus restore electrical power to the secondary distribution panel 24.

While the illustrated embodiment includes a radio receiver 56, it is to be understood that the invention is not limited to use with radio wave receivers. In an alternative embodiment, the radio receiver 56 can be replaced by a conventional 24 volt contactor connected to a central control panel, such as a building security panel, a home security panel, or a guard station in an office building. Thus, a person at a remote location can control the flow of electrical power to one or more secondary distribution panels 24 as needed.

While the above discussion focused on the flow of electrical power to a single secondary distribution panel 24, it is to be understood that multiple secondary distribution panels 24 could be connected to the control device 52. Alternatively, a plurality of control devices 52 could be individually connected to a plurality of secondary distribution panels 24. For example, one control device 52 could be connected to a secondary distribution panel 24 and another control device 52′ could be connected to another secondary distribution panel 24′ (as shown by dashed lines in FIG. 2). The control devices 52, 52′ could be selectively controlled (e.g., such as by having radio wave receivers controlled by different frequencies) such that power could be selectively supplied to or turned off to the secondary distribution panels 24, 24′.

In another aspect of the invention, the control device 52 of the invention could be used to retrofit an existing conventional electrical distribution system. For example, a control device 52 and one or more secondary distribution panels 24 could be electrically connected to an existing primary distribution panel. The electrical lines for selected secondary users could then be transferred from the primary distribution panel to the secondary distribution panel(s) so that power to the secondary users could be controlled as described above.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

The invention claimed is:

1. An electrical distribution system, comprising:
a primary distribution panel;
at least one secondary distribution panel electrically connected to the primary distribution panel; and
a control device in electrical connection with the primary distribution panel and the secondary distribution panel and configured to selectively control the flow of electricity from the primary distribution panel to the secondary distribution panel.

2. The system of claim 1, wherein the control device comprises:
a contactor connected to the primary distribution panel and the secondary distribution panel;
a transformer connected to the contactor; and
a controller connected to the transformer, the controller configured to selectively energize or de-energize the transformer to open or close the contactor.

3. The system of claim 2, wherein the controller is a radio receiver.

4. The system of claim 2, wherein the controller is a 24 volt contactor.

5. The system of claim 2, further including a bypass switch configured to selectively control the flow of electricity from the controller to the transformer.

6. An electrical distribution system, comprising:
a primary distribution panel;
a plurality of primary circuit breakers located in the primary distribution panel;
a plurality of primary electrical lines electrically connected to the primary circuit breakers;
at least one secondary distribution panel electrically connected to the primary distribution panel;
at least one secondary circuit breaker in the secondary distribution panel;
secondary electrical lines connected to the secondary circuit breakers; and
a control device configured to control the flow of electrical power from the primary distribution panel to the secondary distribution panel, wherein the control device comprises:
a contactor connected to the primary distribution panel and the secondary distribution panel;
a transformer connected to the contactor; and
a controller connected to the transformer, the controller configured to selectively energize or de-energize the transformer to open or close the contactor.

7. The system of claim 6, wherein the controller includes a manual switch.

8. The system of claim 6, wherein the secondary distribution panel includes a status indicator.

9. The electrical distribution system of claim 6, wherein the secondary distribution panel is connected to a solenoid valve in a water line or a gas line.

10. An electrical distribution system, comprising:
a primary distribution panel having a plurality of primary circuit breakers, connected to primary users;
at least one secondary distribution panel connected to the primary distribution panel and having a plurality of secondary circuit breakers connected to secondary users; and
a control device configured to control the flow of electrical power from the primary distribution panel to the secondary distribution panel, the control device comprising:
a three pole, single throw contactor;
a transformer connected to the contactor; and
a radio frequency receiver connected to the transformer, wherein the radio frequency receiver is configured to selectively cause the transformer to open or close the contactor.

11. A method of retrofitting an electrical distribution system, comprising the steps of:
electrically connecting at least one control device to a primary distribution panel, the control device comprising:
a contactor;
a transformer connected to the contactor; and
a radio frequency receiver connected to the transformer;
electrically connecting at least one secondary distribution panel to the control device;
designating one or more electrical consumers as secondary consumers;
transforming an electrical connection for the secondary consumers from the primary distribution panel to the secondary distribution panel; and
selectively controlling electricity to the secondary distribution panel by remotely sending a signal to the receiver to cause the transformer to open or close the contactor.
